(19) United States
(12) Patent Application Publication
(10) Pub. No.: US 2018/0283039 A1
(43) Pub. Date: Oct. 4, 2018

(54) FENCING SYSTEMS, COMPONENTS THEREOF AND METHODS FOR USING THE SAME

(71) Applicant: Fireproof, LLC, Big Horn, WY (US)

(72) Inventor: Ryan Schilleman, Sheridan, WY (US)

(21) Appl. No.: 15/940,734

(22) Filed: Mar. 29, 2018

Related U.S. Application Data
(60) Provisional application No. 62/478,468, filed on Mar. 29, 2017.

(51) Int. Cl. E04H 17/12; E04H 17/04

(52) U.S. Cl. CPC E04H 17/12; F16B 45/02; E04H 17/04

(57) ABSTRACT

Fencing systems and components thereof are disclosed herein. In one form, a device for coupling a fence wire to a post is provided. In another form, a method is provided for coupling a fence wire to a post through use of the disclosed device.

### CROSS-REFERENCE TO RELATED APPLICATIONS

This application claims the benefit of U.S. Provisional Patent Application No. 62/478,468 filed Mar. 29, 2017, the content of which is incorporated herein by reference in its entirety.

### BACKGROUND

The present disclosure generally relates to fencing systems and components thereof, and more particularly but not exclusively, to a device for coupling a fence wire to a post.

Fencing systems and components thereof may be subject to assembly complications, damage during use and other issues.

In view of the foregoing, there remains a need for further contributions in this area of technology.

The claimed subject matter is not limited to embodiments that solve any disadvantages or that operate only in environments such as those described above. Rather, this background is only provided to illustrate examples of where the present disclosure may be utilized.

### BRIEF SUMMARY

The present disclosure generally relates to fencing systems and components thereof, and more particularly but not exclusively, to a device for coupling a fence wire to a post.

In one embodiment, a fence clip includes a body including: a first portion configured to engage with a post and a second portion extending from the first portion and defining a receptacle configured to receive a fence wire. The body further defines a mouth which provides access to the receptacle. The fence clip also includes a closure member positionable between a first position, where access to the receptacle through the mouth is prevented, and a second position, where access to the receptacle through the mouth is permitted. In addition, the body is formed from a first material and the closure member is formed from a second material.

In alternative embodiments, assemblies, systems, apparatuses, and devices relating to fences and fencing systems are provided.

This Summary is provided to introduce a selection of concepts in a simplified form that are further described below in the Detailed Description. This Summary is not intended to identify key features or essential characteristics of the disclosed subject matter, nor is it intended to be used as an aid in determining the scope of the disclosed subject matter.

Additional features and advantages will be set forth in the description which follows, and in part will be obvious from the description, or may be learned by the practice of the invention. The features and advantages may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

FIG. 1 is a perspective view of a fencing system.

FIG. 2 is an alternative perspective view of the system of FIG. 1 with certain features omitted.

FIG. 3 is a side view of a fence clip of the system of FIG. 1 illustrating functionality of a closure member.

FIG. 4 is a perspective view of the fence clip of the system of FIG. 1.

FIG. 5 is a side plan view of an alternative embodiment fence clip which may be used in the system of FIG. 1.

FIG. 6 is a side plan view of another alternative embodiment fence clip which may be used in the system of FIG. 1.

FIG. 7 is a side plan view of another alternative embodiment fence clip which may be used in the system of FIG. 1.

FIG. 8 is a side plan view of another alternative embodiment fence clip which may be used in the system of FIG. 1.

FIG. 9 is a plan view of a mounting plate which may be used in the fencing system of claim 1.

FIG. 10 is a plan view of the mounting plate illustrated in FIG. 9 coupled to a post.

FIG. 11 is a plan view of a fencing system illustrating the plate of FIG. 9 coupled to a post and alternative fence clips engaged therewith.

### DETAILED DESCRIPTION

For purposes of promoting an understanding of the present disclosure, reference will now be made to the following embodiments and specific language will be used to describe the same. It will nevertheless be understood that no limitation of the scope of the disclosure is thereby intended, such alterations and further modifications in the described subject matter, and such further applications of the disclosed principles as described herein being contemplated as would normally occur to one skilled in the art to which the disclosure relates.

The terms and words used in the following description and claims are not limited to the bibliographical meanings, but, are merely used to enable a clear and consistent understanding of the disclosure. It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

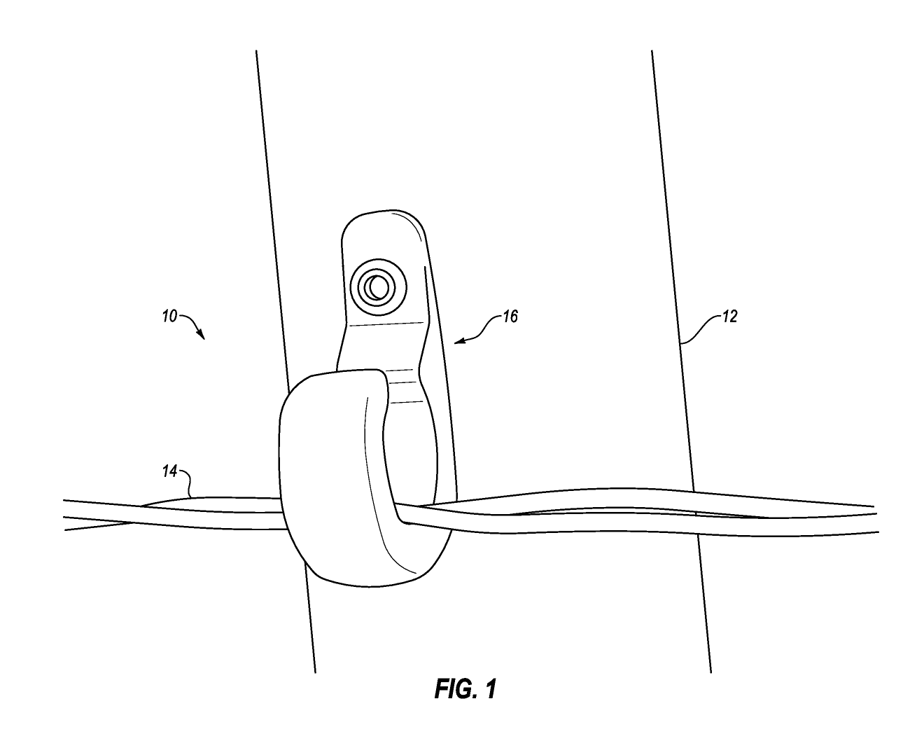

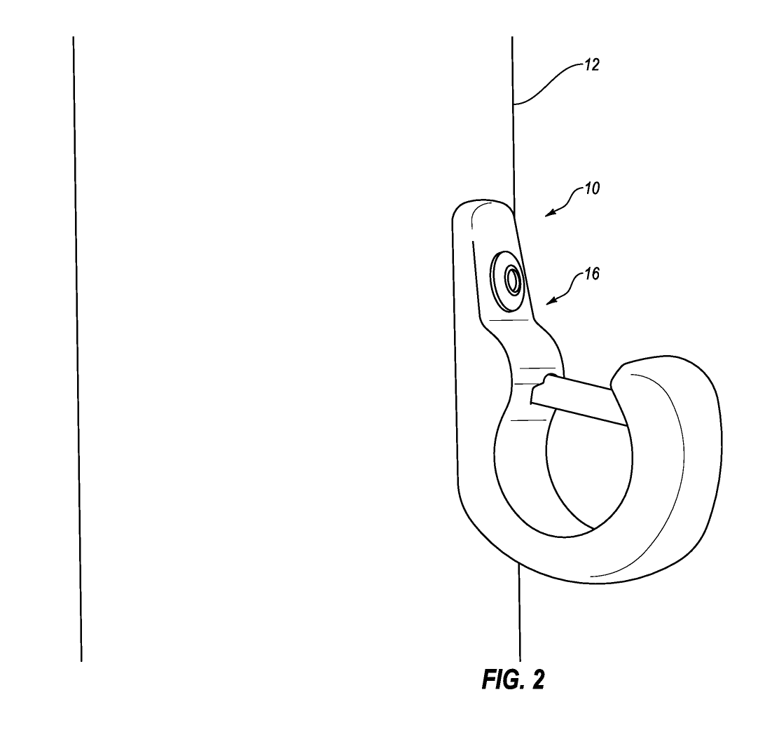

The present disclosure generally relates to fencing systems and components thereof, and more particularly but not exclusively, to a device for coupling a fence wire to a post. Turning now generally to FIGS. 1-2, there is illustrated a fencing system 10 that may be used for any number of purposes, including for example to corral animals such as livestock or to secure an area from outside intrusion. System 10 includes a post 12, a wire 14 and a fence clip 16. In the illustrated embodiment, post 12 is of a tubular metal form, although alternative forms are possible. For example, post 12 could be made of wood, plastic or a composite material, just to provide a few examples. In the illustrated form, wire 14 is a braided wire, such as barbed wire for example, although other forms of wire 14 are possible. For example, wire 14 could be non-braided or flat, just to provide a few possibilities. In the illustrated form, clip 16 is directly coupled to post 12. In other non-illustrated forms, a material may be positioned between clip 16 and post 12. For example, when post 12 is electrically conductive and clip 16 is electrically conductive and wire 14 is electrically charged, an insulating material could be placed between post 12 and clip 16 and/or between clip 16 and wire 14.

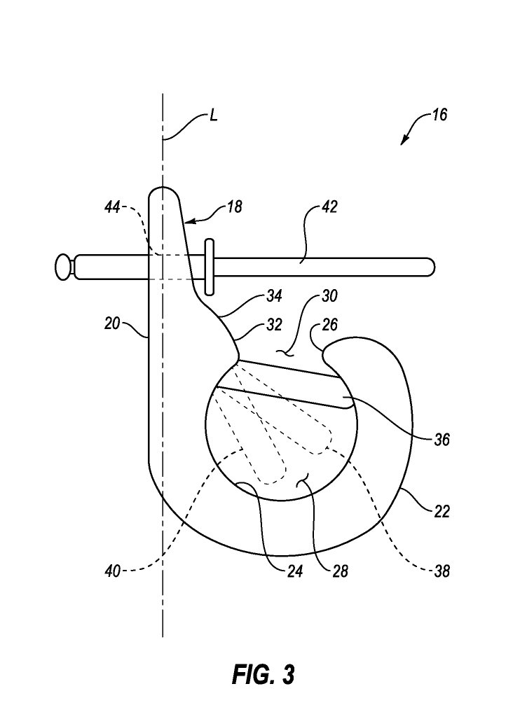

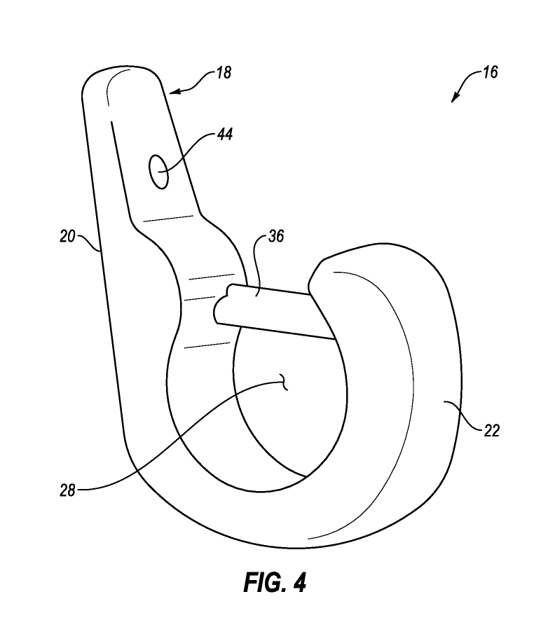

Turning now also to FIGS. 3-4, further details of clip 16 will be provided. Clip 16 includes a body 18 with a first portion 20 which, in the illustrated form, generally extends along longitudinal axis L, although other configurations are contemplated. In the illustrated form, first portion 20 is generally configured to engage against a corresponding linear portion of a post; however, other variations are possible. Body 18 also includes a second portion 22 which extends from first portion 20. More specifically, in the illustrated form, second portion 22 includes an upper surface 24 for example, which first extends arcuately away from longitudinal axis L and then up and back toward longitudinal axis L to end 26. However, other configurations of second portion 22 are contemplated, including a form in which second portion 22 extends linearly or substantially linearly away from longitudinal axis L, linearly or substantially linearly upwardly, and then linearly or substantially linearly back toward longitudinal axis L to end 26.

In this manner, first and second portions 20 and 22 define a receptacle 28 which is configured to receive wire 14. In addition, a mouth 30 (which selectively provides access to receptacle 28 from above when clip 16 is engaged with post 12 in the illustrated manner) is positioned between a projection 32 of first portion 20 and end 26 of second portion 22. Surface 34 of projection 32 may be angled with respect to longitudinal axis L in a manner that directs wire 14 toward mouth 30. Similarly, end 26 may be tapered or chamfered to direct wire 14 toward mouth 30.

Clip 16 further includes a closure member 36 which extends from first portion 20 of body 18 toward second portion 22 of body 18. In the illustrated form, closure member 36 engages against second portion 22 at a location adjacent to end 26, although forms in which closure member 36 engages second portion 22 at a different location are also possible. In addition, forms where closure member 36 extends toward but does not engage second portion 22 are possible. As illustrated in FIG. 3 for example, closure member 36 is in a normal position in which it prevents access to receptacle 28 from mouth 30. However, upon application of sufficient force against closure member 36 from mouth 30 toward receptacle 28, closure member 36 moves, as illustrated in a non-limiting fashion by positions 38, 40 (shown in phantom), in order to provide access to receptacle 28 from mouth 30. Once a force of this nature is no longer applied against closure member 36, it returns to the position illustrated in FIG. 3 such that access to receptacle 28 from mouth 30 is prevented. Similarly, when closure member 36 returns to the illustrated position, an item positioned in receptacle 28 cannot be removed through mouth 30 unless closure member 36 is moved from its normal position. With the foregoing in mind, it should be noted that when closure member 36 is in the illustrated position it controls positioning of an object into receptacle 28 from mouth 30 but not laterally into receptacle 28.

In the context of one non-limiting approach for assembling system 10, clip 16 may be affixed to post 12 with a suitable fastener 42, such as a rivet or screw for example, which extends through aperture 44 of clip 16. In the illustrated form, aperture 44 is positioned above mouth 30, although other variations are possible. Once clip 16 is affixed to post 12, wire 14 may be positioned in mouth 30 of clip 16 and then pulled or forced against closure member 36, causing movement of closure member 36 toward position(s) 38 and/or 40 for example. Once closure member 36 is positioned in this manner, wire 14 is received in receptacle 28, the force from wire 14 is released from closure member 36, and closure member 36 returns to the position illustrated in FIG. 3 in order to prevent release of wire 14 from receptacle 28 through mouth 30. In this configuration, wire 14 is not susceptible to release from clip 16 due to interference by an animal or livestock for example. In the event system 10 needs to be reconfigured, force may be applied against closure member 36 with an appropriate tool or other object to move closure member 36 toward position(s) 38 and/or 40, for example, at which point wire 14 may be removed from receptacle 28 through mouth 30.

In one embodiment, it is contemplated that movement of closure member 36 in the manner discussed above is facilitated by formation of closure member 36 from material(s) that is/are different from the material(s) from which body 18 is formed. In this manner, the different materials are arranged to facilitate deformation of closure member 36 when closure member 36 is moved as discussed above and to prevent deformation of body 18 when closure member 36 is moved as discussed above. Similarly, in one form the only deformation experienced by clip 16 is that of an elastic deflection of closure member 36 initiated when it is desired to position an object such as wire 14 into receptacle 28 through mouth 30. In one form for example, body 18 could be formed of a material that has a higher yield strength than the material from which closure member 36 is formed. In one particular, non-limiting form, closure member 36 may be formed of spring steel and body 18 may be formed of a different material having a higher yield strength.

While not previously discussed, it should be noted that forms where formation of closure member 36 and body 18 is done with different materials may prevent fatigue failure relative to a device where closure member 36 is formed as a tab of body 18, and hence, of the same material. In the latter instance, repeated movement of the tab may cause it to fracture from the remainder of the clip, resulting in release of a wire from the clip and failure of the fencing system. In contrast, the form of clip 16 described herein where body 18 is a rigid member and closure member 36 is formed of a different material affords elastic deflections for repeated engagement/disengagements of a supported object, such as wire 14. Moreover, in the forms where closure member 36 and body 18 are formed of different materials, it is only one portion of clip 16 (closure member 36) and not the main portion of the clip itself which must be moved, deformed, defected, etc. in order to receive and hold a wire. In forms in which the remainder of the clip is structured to plastically deflect or deform, interaction of an animal with a wire held by the clip may cause plastic deflection of the clip and incidentally result in an unplanned release of a wire therefrom.

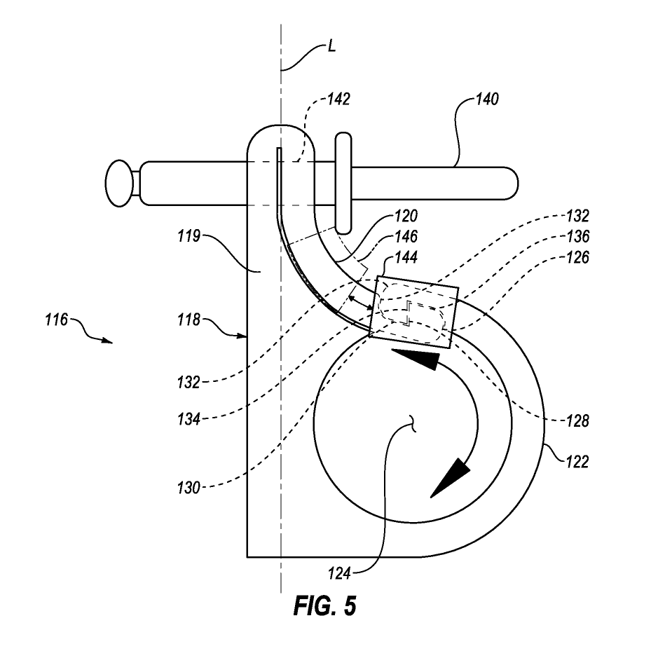

Turning now to FIG. 5, further details of an alternative embodiment fence clip 116 which could be used in system 10 will be provided. Clip 116 includes a body 118 with a first portion 119 which, in the illustrated form, generally extends along longitudinal axis L, although other configurations are contemplated. In the illustrated form, first portion 119 is generally configured to engage against a corresponding linear portion of a post; however, other configurations are possible. Clip 116 also includes a first moveable member 120 which extends from first portion 119 and a second moveable member 122 which extends from first portion 119. In the illustrated form, moveable member 120 first extends generally parallel to first portion 119 and then generally arcuately turns away from longitudinal axis L to end 126, which in the illustrated form, is engaged with moveable member 122. Further, moveable member 122 first extends arcuately away from longitudinal axis L and then up and back toward longitudinal axis L to end 132 which, in the illustrated form, is engaged with moveable member 120. However, other configurations of moveable members 120, 122 are contemplated. An aperture 142 extends through first portion 119 and first moveable member 120 and may receive a fastener 140 to affix clip 116 to a post.

In this manner, first and second moveable members 120, 122 define a receptacle 124 which is configured to receive wire 14. However, first and second moveable members 120, 122 may be moved relative to one another to form a mouth (not shown) which selectively provides access to receptacle 124 from above when clip 116 is engaged with post 12 in the manner illustrated in FIG. 1 for example. Once wire 14 or another object is positioned in receptacle 124, first and second moveable members 120, 122 may be brought back together to the arrangement illustrated in FIG. 5 in order to close the mouth and retain wire 14 or the other object in receptacle 124.

While not previously discussed, it should be noted that moveable member 120 includes a tab 128 positioned adjacent to a receptacle 130, and that moveable member 122 includes a tab 134 positioned adjacent to a receptacle 136. Receptacle 130 is configured to receive tab 134 while receptacle 136 is configured to receive tab 128 in order to selectively hold the first and second moveable members 120, 122 in the illustrated configuration where receptacle 124 is closed. Without being limited to any particular form, it is contemplated that clip 116 could be made from plastic, metal or any other suitable material.

Clip 116 also includes an element 144 which may be used to secure or lock engagement of first and second moveable members 120, 122 in the manner illustrated in FIG. 5. More specifically, once first and second moveable members 120, 122 are engaged as illustrated in FIG. 5, element 144 may be moved along first member 120 from or around position 146 (illustrated in phantom) until it is positioned around first member 120 and second member 122 as illustrated. In this arrangement, the engagement of first and second moveable members 120, 122 is secured by element 144. If disengagement of first and second moveable members 120, 122 is desired, element 144 may be moved along first member 120 to position 146. In the illustrated form, element 144 is formed of a flexible material such that it becomes deformed as it is moved along first moveable member 120 to position 146. However, other forms in which element 144 is formed of a rigid or less flexible material such that it retains its shape as it is moved along first moveable member 120 are also possible. In these forms for example, first moveable member 120 may conform to the shape of element 144 as element 144 is moved along moveable member 120. While element 144 is illustrated and described in connection with being moveable along first moveable member 120, it should be appreciated that forms in which element 144 may be moved along second moveable member 122 in a similar manner are also possible.

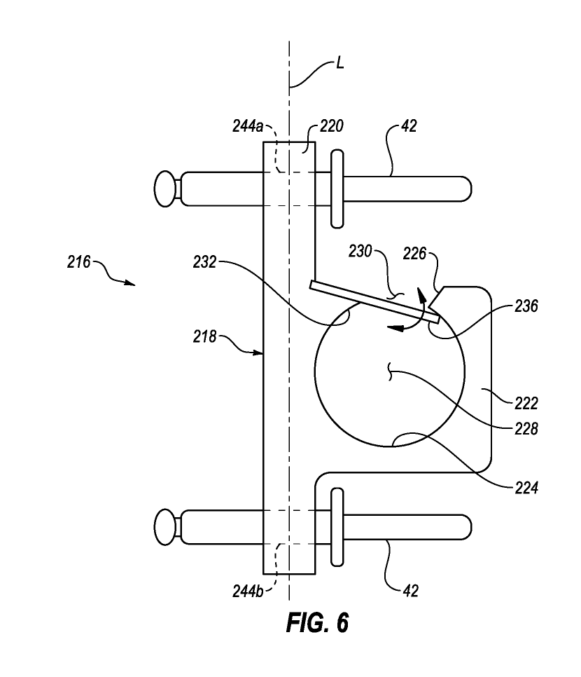

Another alternative embodiment fence clip 216 which could be used in system 10 is illustrated in FIG. 6. Clip 216 includes a body 218 with a first portion 220 which, in the illustrated form, generally extends along longitudinal axis L, although other configurations are contemplated. In the illustrated form, first portion 220 is generally configured to engage against a corresponding linear portion of a post; however, other configurations are possible. Body 218 also includes a second portion 222 which extends from first portion 220. More specifically, in the illustrated form second portion 222 includes an upper surface 224 for example which first extends arcuately away from longitudinal axis L and then up and back toward longitudinal axis L to end 226. However, other configurations of second portion 222 are contemplated, including a form in which second portion 222 extends linearly or substantially linearly away from longitudinal axis L, linearly or substantially linearly upwardly, and then linearly or substantially linearly back toward longitudinal axis L to end 226.

First and second portions 220 and 222 define a receptacle 228 which is configured to receive wire 14. In addition, a mouth 230 (which selectively provides access to receptacle 228 from above when clip 216 is engaged with post 12 in the manner illustrated in FIG. 1 for example) is positioned between a projection 232 of first portion 220 and end 226 of second portion 222. While not previously discussed, end 226 may be tapered or chamfered to direct wire 14 toward mouth 230.

Clip 216 further includes a closure member 236 which extends from first portion 220 of body 218 toward second portion 222 of body 218. In the illustrated form, closure member 236 engages against second portion 222 at a location adjacent to end 226, although forms in which closure member 236 engages second portion 222 at a different location are also possible. In addition, forms where closure member 236 extends toward but does not engage second portion 222 are also possible.

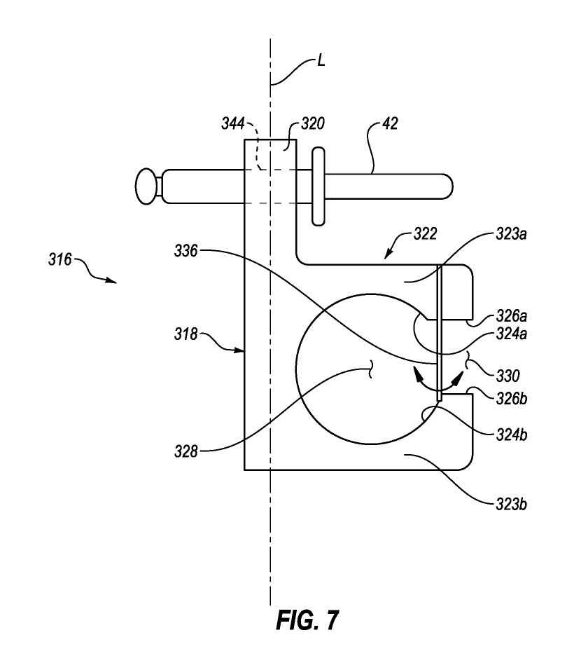

Fence clip 316, which may be used in system 10, is illustrated in FIG. 7. Clip 316 includes a body 318 with a first portion 320 which, in the illustrated form, generally extends along longitudinal axis L, although other configurations are contemplated. In the illustrated form, first portion 320 is generally configured to engage against a corresponding linear portion of a post; however, other configurations are possible. Body 318 also includes a second portion 322 which includes spaced apart portions 323a, 323b which extend from first portion 320. More specifically, in the illustrated form, portion 323a includes a surface 324a which first extends arcuately away from longitudinal axis L and then downwardly toward end 326a, and portion 323b includes a surface 324b which first extends arcuately away from longitudinal axis L and then upwardly toward end 326b. However, other configurations of second portion 322 are contemplated, including forms in which one or both of portions 323a and 323b extends linearly or substantially linearly away from longitudinal axis L and then linearly or substantially linearly upwardly/downwardly.

First and second portions 320 and 322 define a receptacle 328 which is configured to receive wire 14. In addition, a mouth 330 (which selectively provides access to receptacle 328 opposite of first portion 320 of body 318) is positioned between ends 326a, 326b. While not previously discussed, one or both of ends 326a, 326b may be tapered or chamfered to direct wire 14 toward mouth 330.

Clip 316 further includes a closure member 336 which extends from portion 323a of body 318 toward portion 323b of body 318. In the illustrated form, closure member 336 engages against portion 323b at a location adjacent to end 326b, although forms in which closure member 336 engages portion 323b at a different location are also possible. In addition, forms where closure member 336 extends toward but does not engage portion 323b are also possible. Also, in other forms, closure member 336 may extend from portion 323b toward portion 323a of body 318.

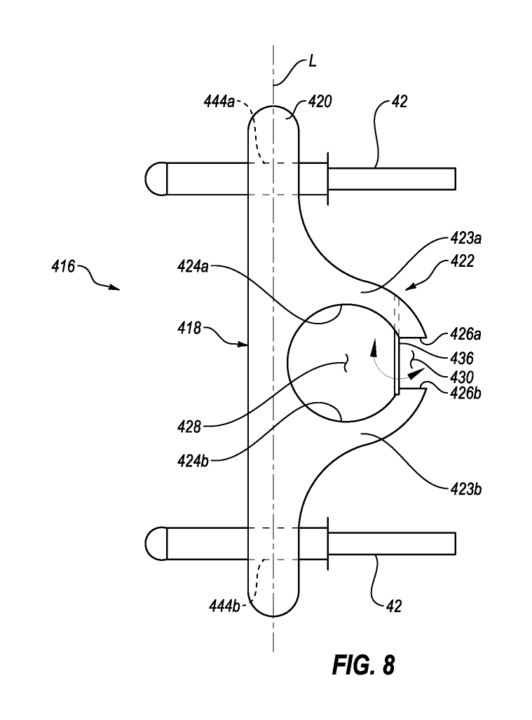

Another alternative embodiment fence clip 416 which could be used in system 10 is illustrated in FIG. 8. Clip 416 includes a body 418 with a first portion 420 which, in the illustrated form, generally extends along longitudinal axis L, although other configurations are contemplated. In the illustrated form, first portion 420 is generally configured to engage against a corresponding linear portion of a post; however, other variations are possible. Body 418 also includes a second portion 422 which includes spaced apart portions 423a, 423b which extend from first portion 420. More specifically, in the illustrated form, portion 423a includes a surface 424a which first extends arcuately away from longitudinal axis L and then downwardly toward end 426a, and portion 423b includes a surface 424b which first extends arcuately away from longitudinal axis L and then upwardly toward end 426b. However, other configurations of second portion 422 are contemplated, including forms in which one or both of portions 423a and 423b extends linearly or substantially linearly away from longitudinal axis L and then linearly or substantially linearly upwardly/downwardly.

First and second portions 420 and 422 define a receptacle 428 which is configured to receive wire 14. In addition, a mouth 430 (which selectively provides access to receptacle 428 opposite of first portion 420 of body 418) is positioned between ends 426a, 426b. While not previously discussed, one or both of ends 426a, 426b may be tapered or chamfered to direct wire 14 toward mouth 430.

Clip 416 further includes a closure member 436 which extends from portion 423a of body 418 toward portion 423b of body 418. In the illustrated form, closure member 436 engages against portion 423b at a location adjacent to end 426b, although forms in which closure member 436 engages portion 423b at a different location are also possible. In addition, forms where closure member 436 extends toward but does not engage portion 423b are also possible. Also, in other forms closure member 436 may extend from portion 423b toward portion 423a of body 418.

Referring now generally to clips 216, 316, 416, similar to clip 16 as described above in connection with FIG. 3, in a normal position closure member 236, 336, 436 prevents access to receptacle 228, 328, 428 from mouth 230, 330, 430. However, upon application of sufficient force against closure member 236, 336, 436 at mouth 230, 330, 430 toward receptacle 228, 328, 428, closure member 236, 336, 436 may be moved in order to provide access to receptacle 228, 328, 428 from mouth 230, 330, 430. Once a force of this nature is no longer applied against closure member 236, 336, 436, it returns to its normal position such that access to receptacle 228, 328, 428 from mouth 230, 330, 430 is prevented. Similarly, when closure member 236, 336, 436 returns to its normal position an item positioned in receptacle 228, 328, 428 cannot be removed through mouth 230, 330, 430 unless closure member 236, 336, 436 is moved from its normal position. With the foregoing in mind, it should be noted that when closure member 236, 336, 436 is in the illustrated position it controls positioning of an object into receptacle 228, 328, 428 from mouth 230, 330, 430 but not laterally (i.e., from the side) into receptacle 228, 328, 428.

In the context of one non-limiting approach for assembling system 10 in which clip 216, 316, 416 is included, clip 216, 316, 416 may be affixed to post 12 with a suitable fastener or fasteners 42, such as a rivet or screw for example, which extends through apertures 244a, 244b of clip 216, aperture 344 of clip 316, or apertures 444a, 444b of clip 416. Once clip 216, 316, 416 is affixed to post 12, wire 14 may be engaged with clip 216, 316, 416 in a manner similar to that described above in connection with clip 16.

In one embodiment, it is contemplated that movement of closure member 236, 336, 436 in the manner discussed above is facilitated by formation of closure member 236, 336, 436 from material(s) that is/are different than the material(s) from which body 218, 318, 418 is formed. In this manner, the different materials are arranged to facilitate deformation of closure member 236, 336, 436 when closure member 236, 336, 436 is moved as discussed above and to prevent deformation of body 218, 318, 418 when closure member 236, 336, 436 is moved as discussed above. Similarly, in one form, the only deformation experienced by clip 216, 316, 416 is that of an elastic deflection of closure member 236, 336, 436 initiated when it is desired to position an object such as wire 14 into or out of receptacle 228, 328, 428. In one form for example, body 218, 318, 418 could be formed of a material that has a higher yield strength than the material from which closure member 236, 336, 436 is formed. In one particular, non-limiting form, closure member 236, 336, 436 may be formed of spring steel and body 218, 318, 418 may be formed of a different material having a higher yield strength. In this form, body 218, 318, 418 may include an aperture or groove (not-illustrated) in which closure member 236, 336, 436 may be positioned and retained through a press fit or other connection means such as welding or fusing.

While not previously discussed, it should be noted that forms where formation of closure member 236, 336, 436 and body 218, 318, 418 is done with different materials may prevent fatigue failure relative to a device where closure member 236, 336, 436 is formed as a tab of body 218, 318, 418, and hence of the same material. In the latter instance, repeated movement of the tab may cause it to fracture from the remainder of the clip, resulting in release of a wire from the clip and failure of the fencing system. In contrast, the form of clip 216, 316, 416 described herein where body 218, 318, 418 is a rigid member and closure member 236, 336, 436 is formed of a different material affords elastic deflections for repeated engagement/disengagements of a supported object such as wire 14. Moreover, in the forms where closure member 236, 336, 436 and body 218, 318, 418 are formed of different materials, it is only one portion of clip 216, 316, 416 (closure member 236, 336, 436) and not the main portion of the clip itself which must be moved, deformed, defected, etc. in order to receive and hold a wire. In forms in which the remainder of the clip is structured to plastically deflect or deform, interaction of an animal with a wire held by the clip may cause plastic deflection of the clip and incidentally result in an unplanned release of a wire therefrom. The components disclosed herein may be provided in a number of different sizes and certain aspects thereof may change depending on intended use. Further, it is intended that clips 16, 116, 216, 316, 416 will allow wire 14 to move within receptacles 28, 124, 228, 328, 428 unless prevented by wire design (for example barbed wire) or frictional forces. As noted above, clips 16, 116, 216, 316, 416 further facilitate engagement and disengagement of wire 14 without removal of clips 16, 116, 216, 316, 416 from a post. The use of clips 16, 116, 216, 316, 416 to engage/hold wire 14 as described herein is not limiting, and it is contemplated that clips 16, 116, 216, 316, 416 may have different intended purposes for other aspects of fencing or other systems.

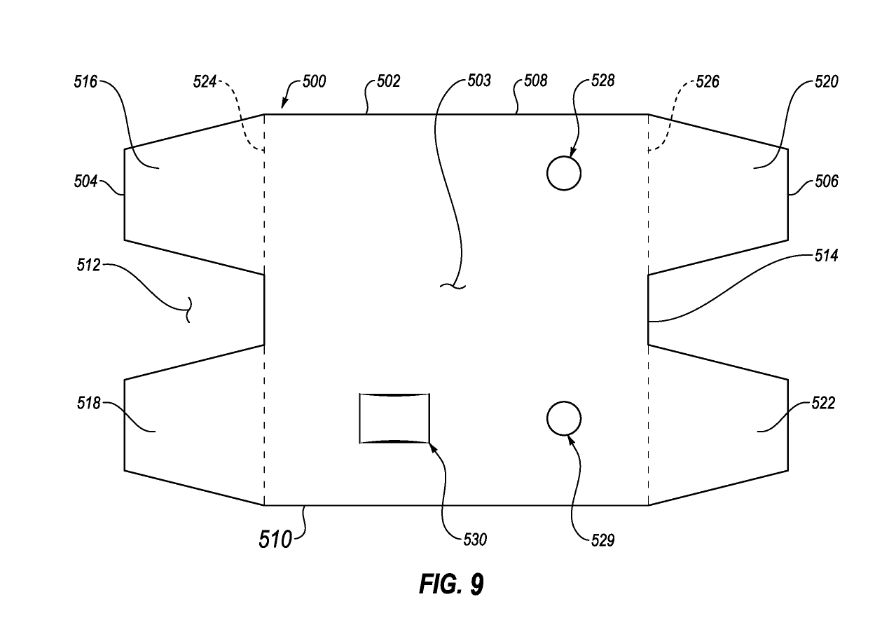

Turning now to FIGS. 9-11, further details will be provided regarding a clip plate 500 and uses thereof in connection with a post and different styles of fence clips. Plate 500 includes a body 502 extending between a first end 504 and a second end 506. Body 502 also includes a portion 503. A first recess 512 is positioned between sides 508 and 510 of plate 500, extends from end 504 toward end 506 and defines tabs 516, 518. A second recess 514 is positioned between sides 508 and 510 of plate 500, extends from end 506 toward end 504 and defines tabs 520, 522. Tabs 516, 518 may be bent relative to the remainder of plate 500 at or near a line 524 and tabs 520, 522 may be bent relative to the remainder of plate 500 at or near a line 526 in order to engage plate 500 to a post such as a t-post or a flat post amongst other possibilities. In one form, plate 500 may include an area at or near lines 524, 526 which promotes bending of tabs 516, 518, 520 and 522. For example, in one form plate 500 could include a perforated section at these areas. In another form, material could be removed at these areas such that the thickness thereof is less than the remaining areas of plate 500. In still another form, plate 500 could be formed such that the thickness of tabs 516, 518, 520 and 522 is less than the remaining portions of plate 500 in order to encourage bending of tabs at or near lines 524, 526. Forms in which plate 500 is formed, at least in part, of spring steel or a similar material are contemplated. In these forms, in addition to or in lieu of perforations or other structural features which promote bending of tabs 516, 518, 520 and 522, tabs 516, 518, 520 and 522 may be pre-bent and the body of plate 500 provides sufficient flex to facilitate engagement of plate 500 with a post. Plate 500 also includes apertures 528, 529 and a sleeve 530, and these features are configured to facilitate engagement of different fence clips to plate 500.

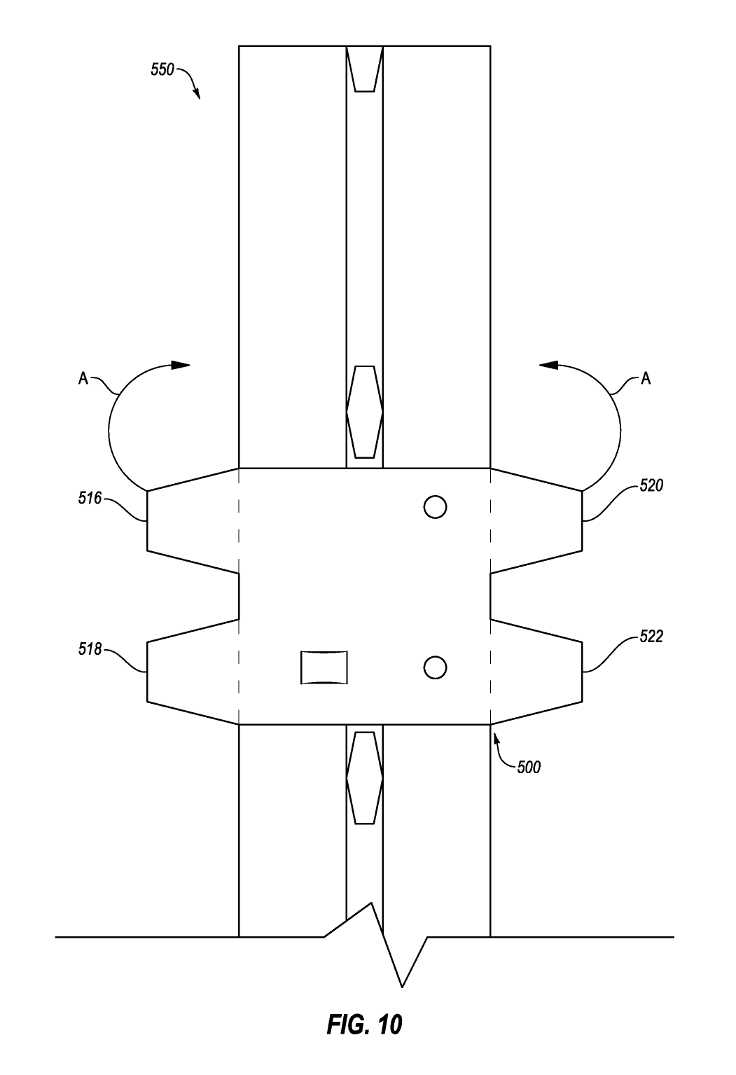

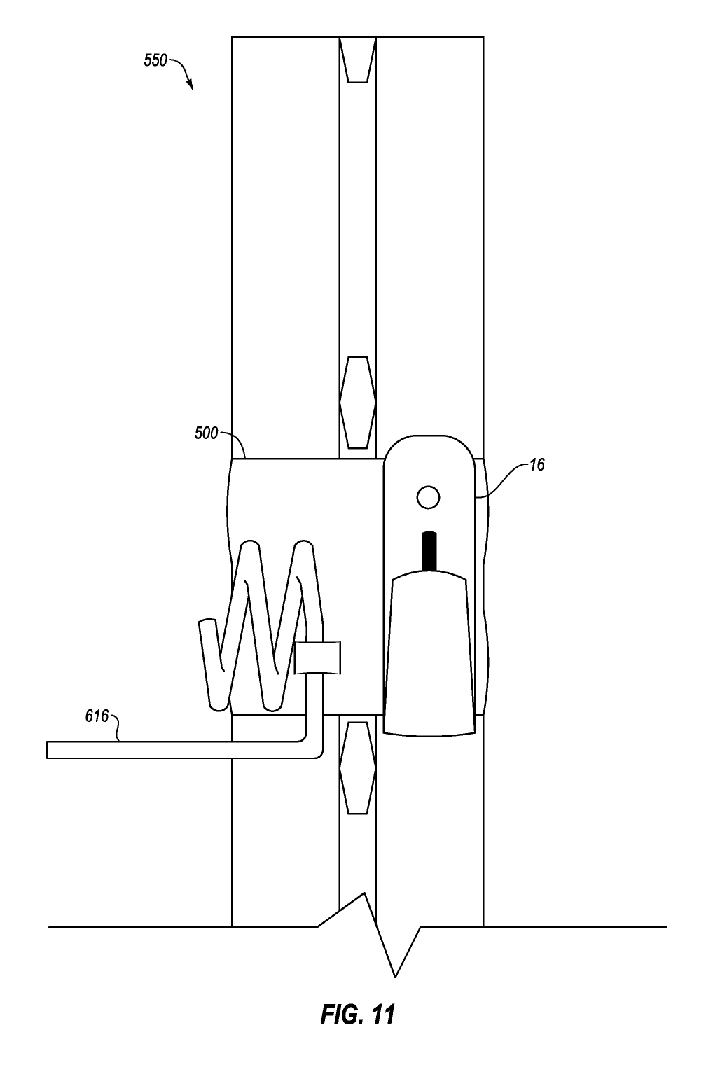

In FIG. 10, plate 500 has been positioned relative to a t-post 550. Once so positioned, tabs 516, 518 may be bent toward post 550 as indicated by directional arrow A and tabs 520, 522 may be bent toward post 550 as indicated by directional arrow B in order to engage plate 500 with post 550 as illustrated in FIG. 11. FIG. 11 also shows a clip 16 engaged with plate 500 through aperture 528 as well as an alternatively arranged clip 616 engaged with plate 500 through sleeve 530. In use, only one of clips 16, 116, 216, 316, 416, 616 may be engaged with plate 500 and a wire could be engaged with the remaining clip in the manner (or a variation thereof) described above.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A fence clip, comprising:
a body including a first portion configured to engage with a post and a second portion extending from the first portion, the first and second portions defining a receptacle configured to receive a fence wire and the body further defining a mouth providing access to the receptacle; and
a closure member positionable between a first position where access to the receptacle through the mouth is prevented and a second position where access to the receptacle through the mouth is permitted;
wherein the body is formed from a first material and the closure member is formed from a second material.

2. The fence clip of claim 1, wherein the first and second materials are structured to facilitate elastic deformation of the closure member when the closure member is moved between the first and second positions and to prevent deformation of the body when the closure member is moved between the first and second positions.

3. The fence clip of claim 1, wherein the second portion is arcuate.

4. The fence clip of claim 1, wherein the first portion generally extends along a longitudinal axis.

5. The fence clip of claim 1, wherein the closure member extends from the first portion of the body toward the second portion of the body.

6. The fence clip of claim 1, wherein the second portion of the body includes a pair of spaced apart portions and the closure member extends from a first of the spaced apart portions toward a second of the spaced apart portions.

7. The fence clip of claim 6, wherein the mouth is positioned between the spaced apart portions of the second portion of the body.

8. The fence clip of claim 1, wherein the first material has a higher yield strength than the second material.

9. The fence clip of claim 1, where the first portion includes a projection extending toward the second portion.

10. The fence clip of claim 1, wherein the closure member engages against the second portion when the closure member is in the first position.

11. A method, comprising:
attaching a fence clip according to any one of claim 1 to a post;
engaging a wire against the closure member of the fence clip to move the closure member from the first position to the second position to provide access to the receptacle through the mouth; and
positioning the wire in the receptacle.

12. The method of claim 11, further comprising allowing the closure member to move from the second position to the first position to prevent release of the wire from the receptacle through the mouth.

13. A fence clip, comprising:
a body including a first portion configured to engage with a post, a first moveable member extending from the first portion, a second moveable member extending from the first portion, and a receptacle defined by the first portion and the first and second moveable members;
wherein the first and second moveable members are moveable between a first orientation where a mouth between the first and second moveable members is formed and provides access to the receptacle, and a second orientation where the first and second moveable members are engaged with one another and access to the receptacle between the first and second moveable members is prevented.

14. The fence clip of claim 13, wherein each of the first and second moveable members includes a tab and a receptacle, and each receptacle is configured to receive the tab from the other moveable member.

15. A system, comprising:
a fence clip according to claim 1;
a post;
and a wire;
wherein the fence clip is configured to engage with the post and the receptacle of the fence clip is configured to receive the wire through the mouth and selectively retain the wire in the receptacle.

16. The system of claim 15, further comprising a plate having a body including a first portion positioned between a first end portion and a second end portion, wherein the first and second end portions are bendable relative to the first portion and configured to engage with a post, the body further including at least one of an aperture and a sleeve configured to facilitate engagement of a fence clip with the first portion.
